(19) United States
(12) Patent Application Publication
(10) Pub. No.: US 2009/0238071 A1
(43) Pub. Date: Sep. 24, 2009

(54) System, method and apparatus for prioritizing network traffic using deep packet inspection (DPI) and centralized network controller

(75) Inventors: Amar Nath Ray, Shawnee, KS (US); John M. Heinz, Olathe, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/052,562

(22) Filed: Mar. 20, 2008

(51) Int. Cl. H04L 12/56

(52) U.S. Cl. 370/235

(57) ABSTRACT

A method, system, and apparatus for prioritizing network traffic according to one embodiment includes receiving a packet addressed to a receiver device from a sender device, and identifying the packet in a network layer to determine an application and/or protocol associated with the packet. The method further includes generating traffic priority information associated with the packet based upon the identifying. The traffic priority information indicates traffic prioritization between the sender device and the receiver device. The method further includes sending the traffic priority information to a network controller. In various embodiments, the packet is identified in the network layer using deep packet inspection.

### BACKGROUND OF THE INVENTION

Deep packet inspection (DPI) is a form of computer network packet filtering that examines a data part of a passing-through data packet to search for non-protocol compliance of predefined criteria to decide if the packet can pass through a network Deep packet inspection is in contrast to shallow packet inspection, generally known as packet inspection, that just checks the header portion of a packet. DPI devices have the ability to look at packets in Layer 2 through Layer 7 of the OSI model that include headers and data protocol structures.

DPI allows service providers to readily know the packets of information that are being received on a communications network, such as the Internet, associated with e-mail, websites, music sharing, video and software downloads in the same or similar manner as a network analysis tool. Up to this point-in-time, DPI has been used for security purposes so that a service provider can identify applications that are using network resources and take action if an undesired application is present.

### SUMMARY OF THE INVENTION

Because many network applications exhibit similar behaviors, it is difficult for a service provider to correctly identify a particular network application and accurately prioritize network traffic in accordance with the identification using existing identification techniques. Embodiments of the invention provide for a system and method for accurately identifying network packets by using deep packet inspection (DPI) to generate information and to prioritize network traffic. Embodiments of the invention provide for (i) identifying specific network applications and/or protocols associated with a received packet in a network layer using deep packet inspection to generate DPI information at an intermediate network node, and (i) sending the DPI information to a centralized network controller. The DPI information may include priority information associated with the packet. The centralized network controller can then prioritize and/or control traffic flowing from a sender device to a receiver device according to the DPI information. Various embodiments allow service providers to prioritize traffic on their networks according to a particular network application and/or protocol in use. For example, a service provider may wish to lower the priority of traffic associated with peer-to-peer file sharing applications.

A method for prioritizing network traffic according to one embodiment includes receiving a packet addressed to a receiver device from a sender device, and identifying the packet in a network layer to determine an application and/or protocol associated with the packet. The method further includes generating traffic priority information associated with the packet based upon the identification. The traffic priority information indicates traffic prioritization between the sender device and the receiver device. The method further includes sending the traffic priority information to a network controller. In various embodiments, the packet is identified in the network layer using deep packet inspection.

An apparatus for prioritizing network traffic according to one embodiment includes processor(s) configured to receive a packet addressed to a receiver device from a sender device, and identify the packet in a network layer to determine an application and/or protocol associated with the packet. The processor(s) are further configured to generate traffic priority information associated with the packet based upon the identifying. The traffic priority information indicates traffic prioritization between the sender device and the receiver device. The processor(s) are further configured to send the traffic priority information to a network controller. In various embodiments, the packet may be identified in the network layer using deep packet inspection.

### BRIEF DESCRIPTION OF THE DRAWINGS

Illustrative embodiments of the present invention are described in detail below with reference to the attached drawing figures, which are incorporated by reference herein and wherein:

FIG. 1 illustrates an embodiment of a system for prioritizing network traffic using deep packet inspection (DPI);

FIG. 2 illustrates an embodiment of a DPI module;

FIG. 3 illustrates an embodiment of an Internet Protocol (IP packet) including DPI information; and

FIG. 4 illustrates an embodiment of a procedure for prioritizing network traffic using deep packet inspection (DPI).

### DETAILED DESCRIPTION

Embodiments of the invention provide for a system and method for identifying network packets using deep packet inspection (DPI). In the past, DPI has been thought of as a security issue, but in embodiments of the present invention, DPI can be used by a service provider to prioritize traffic on their networks. In various embodiments, the DPI identifying information is generated in a network layer (Layer 3 of the simplified Cpen Systems Interconnection (OSI) model) at an intermediate network node and delivered to a centralized network controller. The deep packet inspection information includes priority information associated with a particular network packet. According to various embodiments of the invention, prioritization and traffic shaping is performed by the centralized network controller using the DPI information. Embodiments of the invention allow a network service provider to control traffic between a sender and a receiver without requiring assistance from the sender or the receiver. In such embodiments, the network service provider can control the flow of traffic based upon its own criteria, rather than allowing the sender or the receiver to control the traffic.

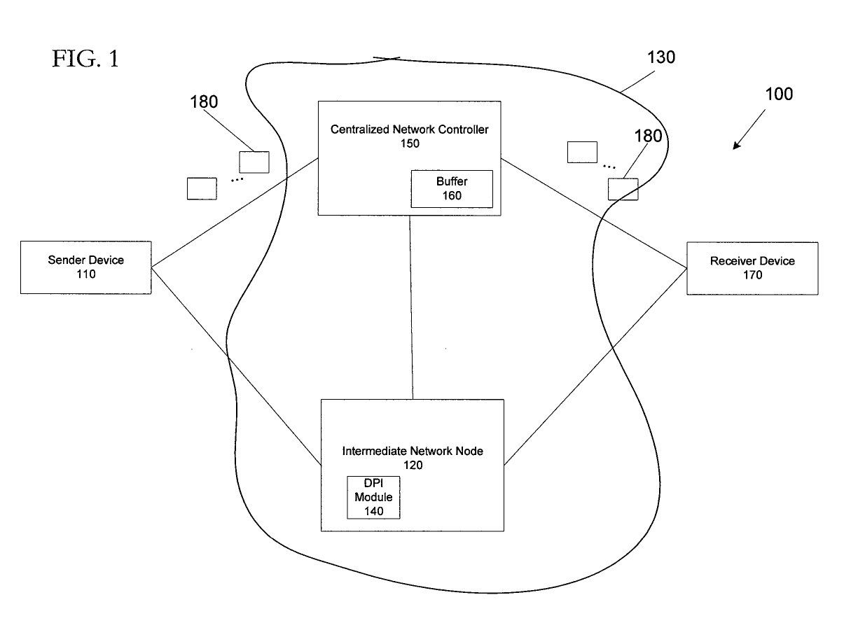

FIG. 1 illustrates an embodiment of a system for prioritizing network traffic using deep packet inspection. The system 100 includes a sender device 110 coupled to an intermediate network node 120 within a network 130. In an example embodiment of the invention, the network 130 is a packet based network The intermediate network node 150 is further coupled to a centralized network controller 150. The intermediate network node 120 is further coupled to a receiver device 170. In an example embodiment, the sender device 110 includes a server (not shown) and the receiver device 170 includes a user terminal (not shown) used to retrieve data from the server. For example, the sender device 110 may include a media server that sends audio and/or video data in data packets 180 to the receiver device 170 upon request. The sender device 110 and the receiver device 170 are further coupled to the centralized network controller 150. In various embodiments, the centralized network controller 150 is operable to control the flow of network traffic between the sender device 110 and the receiver device 170. In at least one embodiment, the centralized network controller 150 includes a network buffer 160. The network buffer 160 is operable to temporarily store one or more packets 180 for use during prioritizing and controlling communication of the packets, as well as providing for desired network performance. In a particular embodiment, the centralized network controller 150 includes at least one processor (not shown) for executing instructions operable to perform the various operations of the centralized network controller 150 described herein. In an example operation, packets 180 transmitted from the sender device 110 to the receiver device 170 that are given a low priority as a result of deep packet inspection by the DPI module 140 are stored in the network buffer 160 of the centralized network controller 150 until packets of a higher priority being communicated from another device (not shown) can be routed to their destination. The network buffer 160 allows for storing of low priority traffic before forwarding the traffic to its destination on a best effort basis.

The intermediate network node 120 includes a deep packet inspection module 140. In a particular embodiment, the DPI module 140 includes at least one processor for executing instructions operable to perform the various operations of the DPI module 140 described herein. The DPI module 140 identifies one or more packets 180, such as internet protocol (IP) packets, as they traverse through the network 130 using deep packet inspection techniques to produce deep packet inspection information. The DPI information includes traffic priority information associated with the packet(s) 180. In at least one embodiment, the DPI information includes information that may be used by various network nodes, such as the centralized network controller 150, the sender device 110, and/or the receiver device 170, to prioritize traffic associated with the packet(s) 180.

With deep packet inspection, signatures are used to identify specific network applications and protocols in use over a network. In their most broad sense, signatures are patterns of data bit “recipes” which are chosen to uniquely identify an associated application or protocol. When a new application or protocol is encountered, the data packets of the new application are analyzed and an appropriate signature is developed and added to a database, typically referred to as a signature library. In an embodiment of the invention, packets transmitted by a particular application or protocol are received, and the packets are analyzed using deep packet inspection to generate a signature. The signature may then be compared to entries in the signature library, and if a match is found, the data packets are identified as being associated with a particular application or protocol identified in the signature library.

Application signatures should be updated on a regular basis as they tend to vary as new application updates or protocol revisions occur. For example, peer-to-peer file sharing applications tend to upgrade their client software on a regular basis and encourage, and, in some cases, even force users to move on to the new release. The use of these new releases with non-up-to-date signatures affect classification performance.

Although a signature is developed with the intention to uniquely and completely identify its related application or protocol, there are cases in which the signature is not robust (a.ka. weak signature) and classification problems arise. False positives is the basic terminology referring to misclassification, or in simple terms, the likelihood that an application will be identified as something it is not. If DPI is being used for guiding a subscriber management tool, this may lead to wrongful actions. A typical example of such a wrongful action could be the mistaken lowering of priorities to time-sensitive streaming traffic and the resultant introduction of unwanted latency or even packet loss. Consequently, when developing signatures, every effort should be made to achieve a low percentage of false positives. A common way to strengthen a weak signature is to use a combination of more than one pattern. False negatives refers to those cases where it is not possible to consistently identify an application—sometimes the identification is classified, while other times it is missed by the classification tool. The most common reason for this phenomenon is that some applications can accomplish similar outcomes in several ways in different deployment scenarios. For example, some applications behave differently if the client software operates through a proxy or firewall compared to a simpler case in which the client interacts with the web directly.

Several analysis techniques are used in deep packet inspection to identify and classify traffic to generate a signature. These range from analysis by port, by string match, by numerical properties, by behavior and heuristics. Analysis by port is probably the easiest and most well known form of signature analysis because many applications use either default ports or some chosen ports in a specific manner. A good example is Post Office Protocol version 3 (POP3) used for email applications. An incoming POP3 connection typically uses port 110, and if it is a secure connection, it will use port 995. The outgoing SMTP is port 25. However, since it is very easy to detect application activity by port, this is in fact a weakness, particularly because many current applications disguise themselves as other applications. The most notorious example is the Port 80 syndrome, where many applications camouflage as pure HTTP traffic. Some applications select random ports instead of using fixed default ports. In this case, there is often some pattern involved in the port selection process, for example, the first port may be random, but the next will be the subsequent one, and so forth. However, in some cases the port selection process may be completely random. For all these reasons, it is often not feasible to use analysis by port as the only tool for identifying applications, but rather as a form of analysis to be used together with other tools.

Analysis by string match involves searching for a sequence (or string) of textual characters or numeric values within the contents of a packet. Furthermore, string matches may include several strings distributed within a packet or several packets. For example, many applications still declare their names within the protocol itself, as in Kazaa, where the string “Kazaa” can be found in the User-Agent field with a typical HTTP GET request. From this example, it is possible to understand the importance of DPI for correct classification. If analysis is performed by port analysis alone, then port 80 may indicate HTTP traffic and the GET request will further corroborate this observation. If the User-Agent field information is missing, this analysis results in inaccurate classification (e.g., HTTP and not Kazaa).

Analysis by numerical properties involves the investigation of arithmetic characteristics within a packet or several packets. Examples of properties analyzed include payload length, the number of packets sent in response to a specific transaction, and the numerical offset of some fixed string (or byte) value within a packet. For example, consider the process for establishing a TCP connection using some user datagram protocol (UDP) transactions in Skype (versions prior to 2.0). The client sends an 18 byte message, expecting in return an 11 byte response. This is followed by the sending of a 23 byte message, expecting a response which is 18, 51 or 53 bytes. Using numerical analysis combined with other techniques of deep packet inspection, such a pattern can be detected and the particular application can be identified.

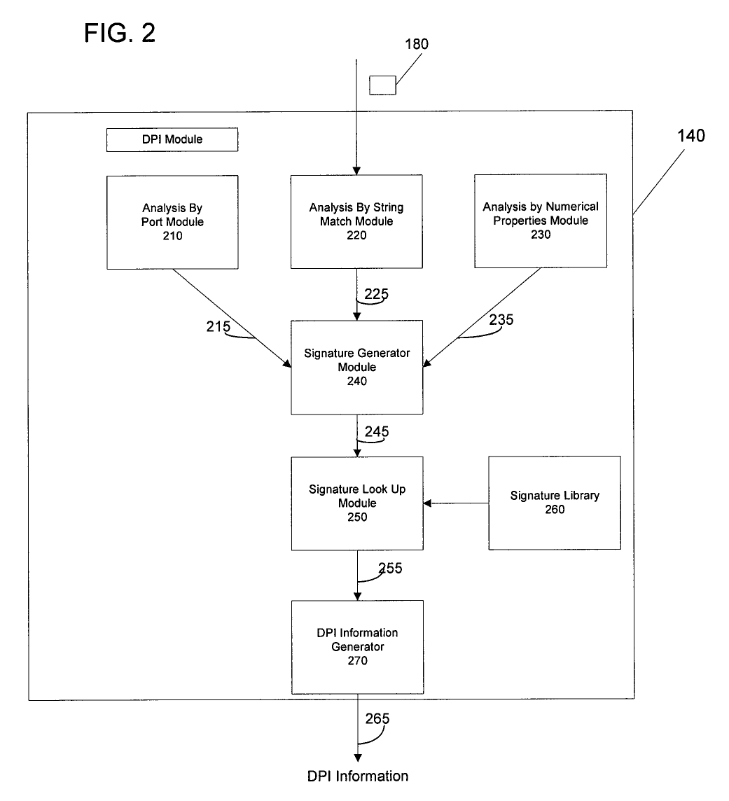

FIG. 2 illustrates an embodiment of a DPI module 140. The DPI module 140 includes an analysis by port module 210, an analysis by string match module 220, and an analysis by numerical properties module 140. The packet 180 is received by the DPI module 140 and is provided to each of the analysis by port module 210, the analysis by string match module 220, and the analysis by numerical properties module 140. The analysis by port module 210 performs analysis by port DPI techniques, such as those described herein, upon the packet 180 to generate a result 215. The analysis by string match module 220 performs analysis by string DPI techniques, such as those described herein, upon the packet 180 to generate a result 225. The analysis by numerical properties module 230 performs analysis by numerical properties DPI techniques, such as those described herein, to generate a result 235. Results 215, 225, and 235 are provided to a signature generator module 240. The signature generator module 240 generates a DPI signature 245 associated with the packet 180 based upon results 215, 225, and 235. The DPI signature 245 is provided to a signature lookup module 250. The signature lookup module 250 performs a lookup of the DPI signature 245 from a signature library 260 to determine an identity 255 of one or more of a particular application and protocol associated with the packet 180. The identity 255 is provided to a DPI information generator 270 that functions to determine DPI information 265 based upon the identity 255.

The DPI module 140 inserts the DPI information into one or more DPI packets. In various embodiments, the DPI information is inserted into a specific field within a network layer packet by the intermediate network node 120 and sent to the centralized network controller 150. In at least one embodiment, the network layer packet is an Internet Protocol (IP) packet.

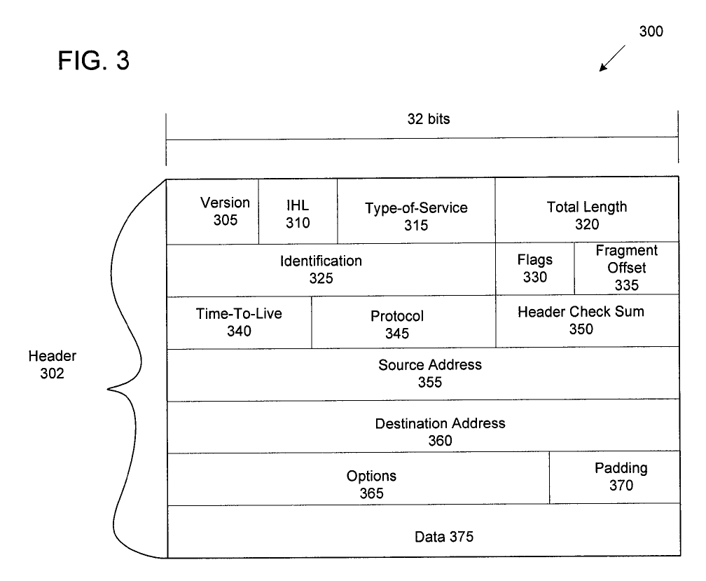

FIG. 3 illustrates an embodiment of an Internet Protocol (IP) packet 300 including DPI information. The IP packet 300 includes a header 302 and a data field 375. The header 302 includes a version field 305 indicating the version of IP used, a IP Header Length (IHL) field 310 indicting the datagram header length in 32-bit words, a Type-of-Service field 315 indicating how the packet 300 is to be handled by an upper-layer protocol, and a total length field 320 indicating the length in bytes of the IP packet 300. The header 302 further includes an Identification field 325 that contains an integer that identifies the current datagram used to help piece together datagram fragments, a Flag field 330 used for fragmentation control, and a Fragment Offset field 335 indicating the position of the fragment's data relative to the beginning of the data in the original datagram. The header 302 further includes a Time-to-Live field 340 including a counter value indicating when the datagram is to be discarded, a protocol field 345 indicating which upper-layer protocol receiving incoming packets after IP processing is complete, and a Header Checksum field 350 including a checksum to help ensure IP header integrity. The header 302 further includes a source address field 355 including the address of the sending node, a destination address field 360 including the address of the receiving node, an options field 365 that includes support for various options such as security, and a padding field 370 including a padding of zeros used to ensure that the header 302 ends on a 32-bit boundary. The data field 375 includes the data payload of the IP packet 300. In at least one embodiment, the DPI information is inserted into the data field 375 of the IP packet 300.

According to a particular embodiment, the DPI information comprises a one-byte DPI inspection code, which may represent an alphanumeric value, that is inserted at the intermediate network node 120 by the DPI module 140 into one or more DPI packets and sent to the centralized network controller 150. The DPI inspection code instructs the centralized network controller 150 on the manner in which the packet and other traffic is to be handled for traffic control purposes. An example of DPI inspection codes includes: a ‘1’ representing the stopping of sending packets, a ‘2’ representing the slowing down of packets, a ‘3’ representing the rerouting of traffic, a ‘4’ representing the stopping of billing for traffic, a ‘9’ representing the continuation of sending of traffic, an ‘A’ representing the pausing of the traffic, and a ‘Z’ representing the prioritizing of the traffic. Alternative codes may be utilized in accordance with the principles of the present invention.

Continuing with FIG. 1, the intermediate network node 120 sends the DPI packet to the centralized network controller 150. Upon receiving the DPI packet, the centralized network controller 150 controls and prioritizes the traffic flowing between the sender device 110 and the receiver device 170 according to the DPI information included in the DPI packet. In some embodiments, the centralized network controller 150 sends the DPI information to one or more of the sender device 110 and the receiver device 170. In some embodiments, the centralized network controller 150 sends the DPI information to one or more of the sender device 110 and the receiver device 170 in the transport layer (Layer 4 of the OSI model). In at least one embodiment, the DPI information is sent to the sender device 110 and/or the receiver device 170 in a Transmission Control Protocol (TCP) packet. In such embodiments, the sender device 110 and/or the receiver device 170 will also control and/or prioritize traffic between sender device 110 and the receiver device 170 according to the DPI information.

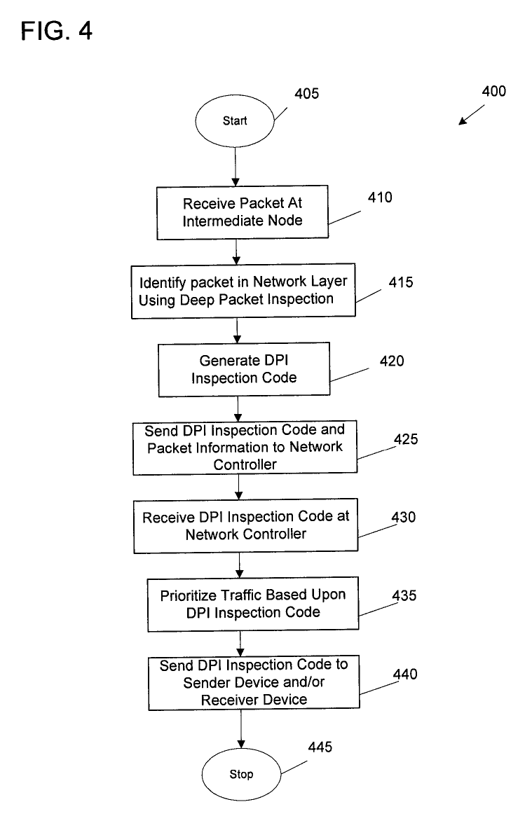

FIG. 4 illustrates an embodiment of a procedure for prioritizing network traffic using deep packet inspection. The procedure 400 begins in step 405. In step 410, a packet sent from the sender device 110 (FIG. 1), and addressed to the receiver device 170, is received at the intermediate network node 120. In step 415, the packet is identified in the network layer by the DPI module 140 using deep packet inspection, such as by using one or more of the techniques for deep packet inspection described herein. Identification of the packet by deep packet inspection allows the DPI module 140 to determine the identity of one or more of a particular application and protocol that the sender device 110 and the receiver device 170 are using to communicate with one another, and generate DPI information in the form of a DPI inspection code based on the identification of DPI code(s). The DPI inspection code may include traffic priority information that indicates how traffic between the sender device 110 and the receiver device 170 is to be prioritized.

In step 425, the intermediate network node 120 sends the DPI inspection code, and optionally other identifying information regarding the packet, to the centralized network controller 150 within a DPI packet. In a particular embodiment of the invention, the DPI module 140 inserts the DPI inspection code into a network layer packet. In at least one embodiment, the network layer packet is an IP packet. In step 430, the centralized network controller receives the DPI packet and reads the DPI inspection code from the DPI packet. In step 435, the centralized network controller 150 prioritizes and/or controls traffic between the sender device 110 and the receiver device 170 according to the DPI code information contained within the DPI packet. In at least one embodiment, in an optional step 440, the centralized network controller 150 sends the DPI inspection code to one or more of the sender device 110 and the receiver device 170. In such embodiments, the sender device 110 and the receiver device 170 may also control and/or prioritize traffic between sender device 110 and the receiver device 170 according to the DPI information. In step 445, the procedure 400 ends. In some embodiments, the DPI module 140 in the intermediate network node 120 continues to perform DPI on the packets transmitted between the sender device 110 and the receiver device 170, and sends updated DPI information to the centralized network controller 150 if a change occurs in the traffic that requires a change in prioritization for the traffic.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communication link This communication link may use a medium that is, for example without limitation, physical or wireless.

The previous detailed description is of a small number of embodiments for implementing the invention and is not intended to be limiting in scope. One of skill in this art will immediately envisage the methods and variations used to implement this invention in other areas than those described in detail. For example, although the described embodiments are directed to deep packet inspection being performed at an intermediate network node, it should be understood that these procedures may be performed at any node within the network. Although some particular embodiments are described with respect to using DPI in a network layer, it should be understood that the principles described herein may be used with any layer regardless of the particular network configuration or technologies used. The following claims set forth a number of the embodiments of the invention disclosed with greater particularity.

What is claimed as new and desired to be protected by Letters Patent of the United States is:

1. A method for prioritizing network traffic comprising:
receiving a packet from a sender device, the packet addressed to a receiver device;
identifying the packet in a network layer to determine at least one of an application or protocol associated with the packet;
generating traffic priority information associated with the packet based upon identifying the packet, the traffic priority information indicating traffic prioritization between the sender device and the receiver device; and
sending the traffic priority information to a network controller.

2. The method of claim 1, further comprising:
prioritizing, by the network controller, traffic between the sender device and the receiver device in accordance with the traffic priority information.

3. The method of claim 1, wherein identifying the packet in the network layer includes identifying the packet in the network layer using deep packet inspection.

4. The method of claim 1, wherein sending the traffic priority information to the network controller includes sending the traffic priority information to the network controller in the network layer.

5. The method of claim 1, further comprising sending the traffic priority information to at least one of the sender device and the receiver device.

6. The method of claim 5, wherein sending the traffic priority information to at least one of the sender device and the receiver device includes sending the traffic priority information in a transport layer.

7. The method of claim 1, wherein the traffic priority information includes a deep packet inspection code.

8. The method of claim 1, wherein identifying the packet in the network layer includes performing analysis by port on the packet.

9. The method of claim 1, wherein identifying the packet in the network layer includes performing analysis by string match on the packet.

10. The method of claim 1, wherein identifying the packet in the network layer includes performing analysis by numerical properties on the packet.

11. An apparatus for prioritizing network traffic comprising:
at least one processor, the at least one processor configured to:
receive a packet from a sender device, the packet addressed to a receiver device;
identify the packet in a network layer to determine at least one of an application or protocol associated with the packet;
generate traffic priority information associated with the packet based upon the identifying, the traffic priority information indicating traffic prioritization between the sender device and the receiver device; and
send the traffic priority information to a network controller.

12. The apparatus of claim 11, wherein the network controller is configured to prioritize traffic between the sender device and the receiver device in accordance with the traffic priority information.

13. The apparatus of claim 11, wherein the at least one processor is configured to identify the packet in the network layer by identifying the packet in the network layer using deep packet inspection.

14. The apparatus of claim 11, wherein the at least one processor is configured to send the traffic priority information to the network controller by sending the traffic priority information to the network controller in the network layer.

15. The apparatus of claim 11, wherein the network controller is configured to send the traffic priority information to at least one of the sender device and the receiver device.

16. The apparatus of claim 15, wherein the network controller is configured to send the traffic priority information to the at least one of the sender device and the receiver devices by including the traffic priority information in a transport layer.

17. The apparatus of claim 11, wherein the traffic priority information includes a deep packet inspection code.

18. The apparatus of claim 11, wherein the at least one processor is configured to identify the packet in the network layer by performing analysis by port on the packet.

19. The apparatus of claim 11, wherein the at least one processor is configured to identify the packet in the network layer by performing analysis by string match on the packet.

20. The apparatus of claim 11, wherein the at least one processor is configured to identify the packet in the network layer by performing analysis by numerical properties on the packet.
